(19) United States
(12) Patent Application Publication
(10) Pub. No.: US 2025/0376312 A1
(43) Pub. Date: Dec. 11, 2025

(54) Metallized High Barrier Paper Food Packaging

(71) Applicant: General Mills, Inc., Minneapolis, MN (US)

(72) Inventors: Sandra Dehnbostel, Minneapolis, MN (US); George A. Tuszkiewicz, River Falls, WI (US)

(73) Assignee: General Mills, Inc., Minneapolis, MN (US)

(21) Appl. No.: 18/876,533

(22) PCT Filed: Nov. 6, 2023
(86) PCT No.: PCT/US2023/036861

§ 371 Date: Dec. 18, 2024

Related U.S. Application Data
(60) Provisional application No. 63/423,677, filed on Nov. 8, 2022.

(51) Int. Cl. B65D 65/40; B32B 7/12; B32B 29/00; B32B 29/06

(52) U.S. Cl. CPC B65D 65/40; B32B 7/12; B32B 29/005; B32B 29/06; B32B 2250/02; B32B 2255/12; B32B 2255/205; B32B 2307/718; B32B 2307/7244; B32B 2439/70; B65D 2565/387

(57) ABSTRACT

A barrier-type paper (18) with a non-barrier paper (16) uses suitable laminating adhesives to form a food packaging material. More specifically, a preferred embodiment of the invention is directed to a metallized or aluminum oxide coated paper sheet (20, 21) laminated to a bleached paper sheet (16) using suitable laminating adhesive (26). The following additional layers may be added: a cold seal adhesive layer (33), an ink layer (34), and/or a cold seal release over lacquer layer (32).

### FIELD OF THE INVENTION

The invention generally pertains to packaging materials, particularly for food products. More specifically, the present invention relates to food packaging materials exhibiting barrier properties with regard to the transfer of moisture and oxygen, without the use of plastics in the materials.

### BACKGROUND OF THE INVENTION

Plastic materials have long been employed in producing food packaging. Plastic has desirable properties as a barrier to moisture and oxygen, which often need to be blocked to keep food products from spoiling. Multipolymer plastic film is generally rendered non recycleable, and without being recycled, plastic can accumulate in the environment as a source of pollution. In addition, recycling of plastic materials can be complex and may be limited by recycling infrastructure and end use market applications

When forming food packaging, plastic materials can be formed as films, with the films being shaped to hold food products. For example, United States Patent Application Publication No. 2005/0281923, which is incorporated herein by reference, discloses a heat stable film used both as a processing aid and to form a package for a dough product. However, such films are usually made of plastics, such as polyethene, terephthalate, nylon or the like. United States Patent Application Publication No. US2017/0107034, which is also incorporated herein by reference, discloses compostable coatings and polymers added to a metallized paper for the purposes of compostability. However, such compostable coatings and polymers do not lend themselves to recyclability.

Other food packaging films are used to hold food products during cooking. For example, U.S. Pat. No. 4,450,180, incorporated herein by reference, discloses a microwave popcorn bag formed from flexible sheet material such as a grease proof paper. It is also known to add a metalized susceptor to facilitate heating of popcorn by a microwave oven. However, such containers suffer from leaking of water, oil or grease through the bag.

Other materials besides plastic have been employed as a barrier to the transfer of water and oxygen. A barrier-type paper is a paper that performs a water and oxygen barrier function. By contrast, non-barrier paper allows for the transfer of water and oxygen. For example, bleached paper sheet is a non-barrier paper. Generally, some types of coated paper, for example, the metallized paper disclosed in World document WO2022023077, incorporated herein by reference, can provide some water and oxygen barrier functions and are considered to be barrier-type paper. However, for the most part, the barrier properties of coated paper are inferior to the barrier properties of plastic films and often these properties can be compromised during handling of the packaging made from the coated paper. As a result, there is a need in the art to produce recyclable packaging without employing plastic that still exhibit desirable moisture barrier properties.

### SUMMARY OF THE INVENTION

To address the problems mentioned above, a preferred embodiment of the invention includes laminating a barrier-type paper with a non-barrier paper using laminating adhesives suitable in forming a food packaging material. More specifically, a preferred embodiment of the invention is directed to a metallized paper sheet laminated to 25 #bleached paper sheet using suitable laminating adhesive.

Another preferred embodiment includes a food packaging material formed with the following layers: a cold seal adhesive layer, a metallized or aluminum oxide coated paper sheet, a water based, solventless or solvent based adhesive layer, a bleached paper sheet, an ink layer, and a cold seal release over lacquer layer. The laminating adhesives and paper sheets employed under the invention, which are not selected for barrier properties but are selected for reasons such as their adhesive qualities and cost respectively, have surprisingly resulted in improved barrier properties.

While the metallized paper or aluminum oxide coated alone has a satisfactory water and oxygen barrier function with transfer rates of approximately 0.079 g H₂O/100 in²/day and approximately 0.639 cc O²/100 in²/day respectively, the addition of laminated paper produces synergistic results, particularly reducing water transfer by about 75% to about 0.021 g H₂O/100 in²/day and reducing oxygen transfer by 90% or more to about 0.0463 cc O²/100 in²/day. This result is not only a surprising and extraordinary improvement in barrier properties of a high barrier paper, but also puts the barrier properties of a paper-based product on par with current metallized plastic film packaging. Metallized paper, such as paper having weight of about 63 g/m², is fairly fragile. In addition to improving barrier function, laminating the metalized paper to paper improves mechanical strength of the resulting packaging which can then resist damage during handling/production. This result also has implications for renewability of packaging materials and is curbside recyclable.

Additional objects, features and advantages of the invention will become more readily apparent from the following detailed description when taken in conjunction with the drawings wherein like reference numerals refer to corresponding parts in the several views.

### BRIEF DESCRIPTION OF THE DRAWINGS

FIG. 1 shows a multi-layer food packaging material for containing food including a barrier-type paper sheet laminated to a non-barrier paper sheet with an adhesive according to a first embodiment of the invention.

FIG. 2 shows a multilayer food packaging material including a barrier-type paper sheet laminated to a non-barrier paper sheet having additional layers including a cold seal release, ink and a cold seal adhesive according to a second preferred embodiment of the invention.

FIG. 3 is a flow chart showing a process for producing the multi-layer food packaging of FIG. 2.

FIG. 4 shows a container formed of the multi-layer food packaging of FIG. 1 in the form of a cup for containing food.

FIG. 5 shows a container formed of the multi-layer food packaging of FIG. 2 for containing popcorn.

### DETAILED DESCRIPTION OF THE INVENTION

The following detailed description should be read with reference to the drawings in which similar elements in different drawings are numbered the same. The detailed description and the drawings, which are not necessarily to scale, set forth illustrative and exemplary embodiments and are not intended to limit the scope of the disclosure. Selected features of any illustrative embodiment can be incorporated into an additional embodiment unless clearly stated to the contrary. While the disclosure is amenable to various modifications and alternative forms, specifics thereof have been shown by way of example in the drawings and will be described in detail. As used herein in the specification and claims, including as used in the examples and unless otherwise expressly specified, all numbers may be read as if prefaced by the word “about” or “approximately,” even if the term does not expressly appear, with it being understood that this provides a reasonable expected range of values in the order of +/−10% of the stated value (or range of values). In addition, any numerical range recited herein is intended to include all sub-ranges subsumed therein. Overall, it should be understood, however, that the intention is not to limit aspects of the disclosure to the particular illustrative embodiments described. On the contrary, the intention is to cover all modifications, equivalents, and alternatives falling within the spirit and scope of the disclosure.

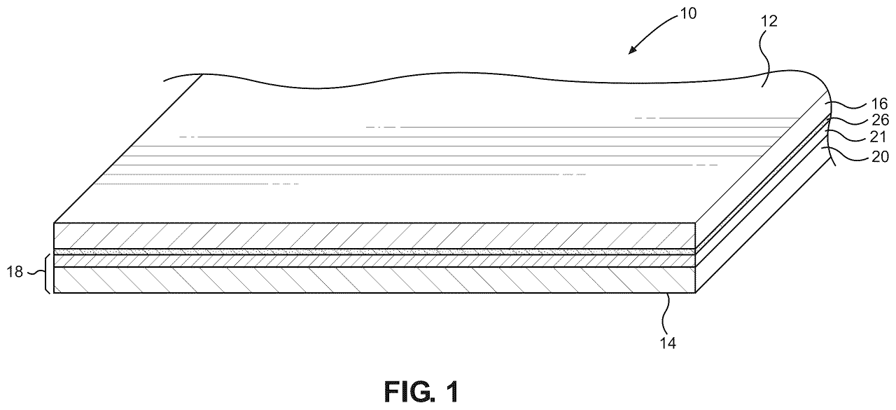

FIG. 1 is a perspective view of a sheet of multi-layer food packaging 10 for containing food according to a first preferred embodiment of the invention. Multi-layer food packaging 10 has an outer surface 12, and an inner surface 14 configured to face a product carried by the multi-layer food packaging 10. Outer surface 12 is formed by a non-barrier paper sheet 16. Inner surface 14 is formed by a barrier-type paper sheet 18 which, in turn, can be constituted by a metallized paper with a paper layer 20 and a metal coating 21. Barrier-type paper sheet 18 is laminated to a non-barrier paper sheet 16 with adhesive layer 26. Preferably metal coating 21 is on the top side of paper layer 20 adjacent to an adhesive layer 26.

Non-barrier paper sheet 16 can be formed from an 25 #bleached paper and, more preferably, a bleached Kraft paper. Bleached Kraft paper undergoes a treatment using bleach and other chemicals to whiten and purify the natural Kraft pulp. Through this process, the paper becomes stronger than traditional brown Kraft paper. Because of this added strength, white bleached Kraft paper is used heavily in wrapping and packaging. While 25 #basis weight is preferable, the bleached paper may vary in basis weight from 18 #to 120 #. Non-barrier paper sheet 16 preferably has a thickness of about 0.5 mils to about 4.7 mils. The bleached paper is tasteless, non-toxic and recyclable.

Barrier-type paper sheet 18 can be a metallized paper, again essentially a paper 20 with a metal coating 21. Such metallized paper is available commercially and sold by Nissha Metalizing Solutions. Metallized paper is available in different weights, but about 63 grams per square centimeter +/−5% is considered desirable. The metallized paper is preferably formed of over 90% paper products and, more preferably, about 95%, and has a low moisture vapor transmission rate of about 0.079 g H₂O/100 in²/day and a low oxygen transfer rate of about 0.639 cc O²/100 in²/day. The thickness is preferably 2.2 mils +/−15% and the tensile strength is between 45 and 48 N/m². The metallized paper has glossy metal side formed by aluminum deposition. While shown with metal coating 21 on one side of barrier-type paper sheet 18, both sides of paper layer 20 may be coated or, alternatively in a less preferred embodiment, the metal may be located on barrier-type paper sheet 18 and opposite adhesive layer 26 to form surface 14. Other alternative arrangements could employ a machine glazed paper for barrier-type paper sheet 18 in place of metallized paper, in order to provide for reduced water and oxygen transfer rates.

As indicated above, non-barrier paper sheet 16 and barrier-type paper sheet 18 are preferably laminated together with adhesive layer 26. The addition of non-barrier paper reduces water transfer by a least about 75% to less than about 0.021 g H₂O/100 in²/day and reduces oxygen transfer by 90% or more to less than about 0.0463 cc O²/100 in²/day. The adhesive employed is preferably a laminating adhesive that does not include any solvent since such adhesives are specifically designed to work with flexible film and for food handling. Non-solvent adhesives also do not interfere with recycling multi-layer food packaging 10. However, a solvent, a water based, or even a laminating film could be employed. Non-barrier paper sheet 16 and barrier-type paper sheet 18 are preferably laminated using a laminating adhesive that is suitable for use around food.

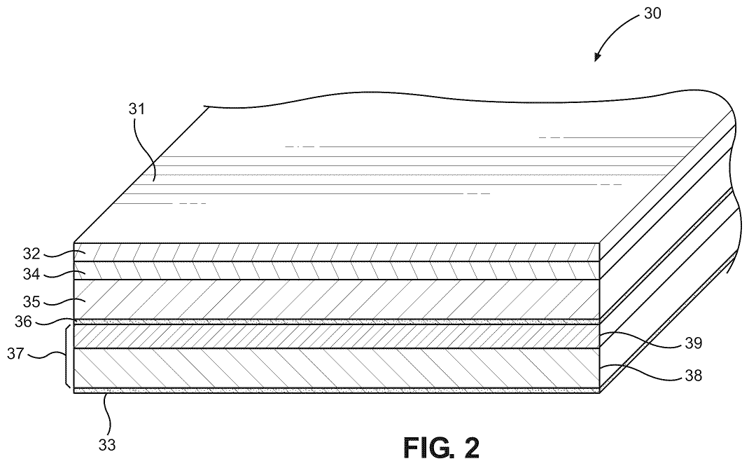

FIG. 2 shows a multilayer packaging 30 according to a second preferred embodiment. Multilayer packaging 30 has an outer surface 31 established by cold seal release lacquer 32, and an inner surface formed of cold-seal adhesive 33. An ink layer 34 is formed on a non-barrier paper sheet 35 which is laminated with an adhesive 36 to a barrier or metallized paper sheet 37 having a paper layer 38 and a metallized coating 39.

Cold seal release lacquer 32 is a protective layer for ink layer 34. Ink layer 34 is formed of conventional ink. Preferably the ink has low odor, low migration, and is non-toxic. To protect ink layer 34, the printing ink surface is coated with protective lacquer, cold seal release lacquer 32, that forms a barrier coating. Cold seal release lacquers are generally a polyamide or nitrocellulose/polyamide blend system designed to act as a protective coating for the printed side of a film package. More details of cold seal release lacquers are found in U.S. Pat. No. 5,466,734, incorporated herein by reference.

Ink layer 34 and cold seal release lacquer 32 are applied through conventional printing type operations (rotogravure, flexographic) or otherwise securely applied upon non-barrier paper sheet 35 which is the same type of material forming non-barrier paper sheet 16 described above with reference to FIG. 1. Likewise, non-barrier paper sheet 35 is laminated with adhesive 36 to metallized paper sheet 37, which is formed the same way as barrier-type paper sheet 18, also as described above with regard to FIG. 1.

Cold-seal adhesive 33 is an adhesive that is applied through conventional printing type operations (rotogravure, flexographic) on the backside of multilayer packaging 30. Once applied to a substrate, the cold-seal adhesive is designed to adhere, with relatively low pressure, only to another layer of cold-seal adhesive. Cold seal adhesives are also called self-seal adhesives. The technology used to create these adhesives is varied, some of the adhesives contain natural rubber latex of various percentages. Some cold seal adhesives are latex free. Other components are added, such as synthetic polymers to improve adhesion and antifoam to ensure the adhesive meets performance specifications. The packaging speed of cold-seal packaging can be much faster than that of heat-seal packaging.

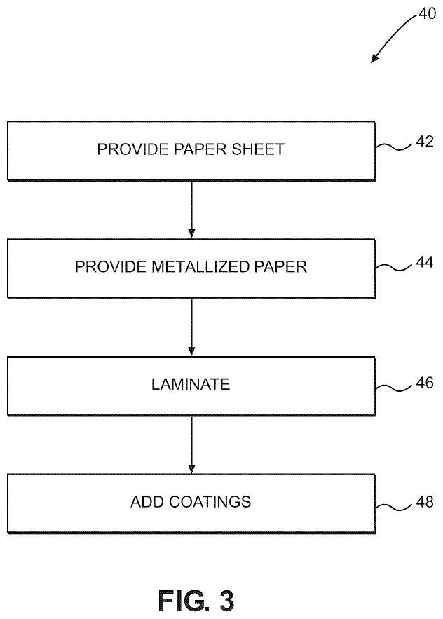

FIG. 3 schematically illustrates a method 40 of manufacturing the packaging material of FIG. 2. The process starts at step 42 providing a bleached Kraft paper that has been treated with bleach and other chemicals to whiten and purify the natural Kraft pulp. At step 44, metallized paper is provided. The paper is preferably metallized by adding an aluminum deposition layer. During production, paper layer 38 is preferably precoated with a base varnish (not shown). Metal coating 39, which is approximately 30-90 nanometers thick, is preferably formed by evaporating aluminum in a vacuum environment and then depositing the aluminum onto the paper layer 38. Metal coating 39 preferably has an optical density of 2.5-4.5 OD. Metal coating 39 may be further coated, or roll finished to have the metal coating 39 be printable. Next, at 46, bleached paper 35 and metalized paper 37 are laminated together with adhesive 36. Preferably, during production, one of the paper sheets, preferably non-barrier paper sheet 35, is coated with adhesive 36 and then both layers are sent through two opposing rollers (not shown) to compression bond the layers together, but other methods of manufacture may be employed. At 48, other layers may be added, such as cold-seal adhesive 33 or ink layer 34 covered with cold seal release lacquer 32.

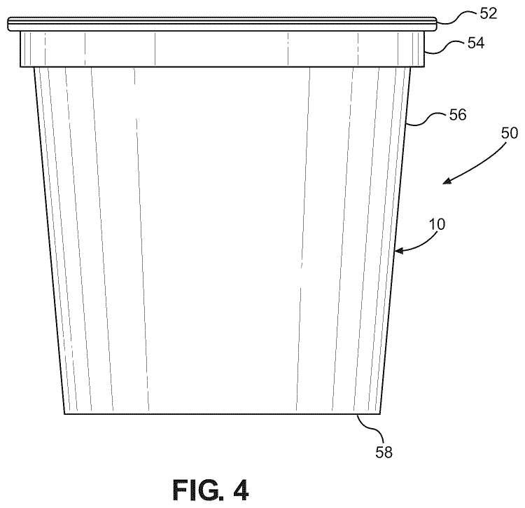

FIG. 4 depicts a flexible paper cup 50 for holding food, such as yogurt, made from multi-layer food packaging 10, discussed above with regard to FIG. 1. Cup 50 has a top rim 52 formed on an upper side wall 54 of constant diameter. A lower side wall 56 tapers inward while extending to a bottom wall 58. More details of various food containing cups may be found in US Patent Publication No. 2017/01017034, incorporated herein by reference.

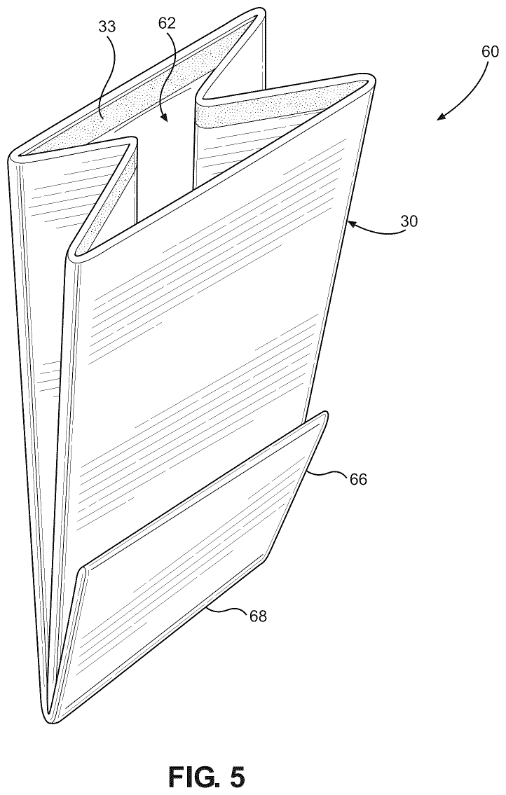

FIG. 5 shows a bag 60 formed from packaging material 30 of FIG. 2. Bag 60 has an upper portion surrounding an opening 62 and a lower portion 66 folded against the upper portion at a fold line 68. When in a vertically aligned orientation, the bag has a top sealable area using cold-seal adhesive 33 along opposing opening edges. With this arrangement, after being filled, opening 62 is sealed by pressing cold-seal adhesive 33 on one side of opening 62 with another portion of cold seal-adhesive 33 (not shown) to close bag 60.

Based on the above, it should be readily apparent that the invention provides for a packaging film that is resistant to vapor and oxygen transfer and is easily recyclable. In any case, although disclosed with reference to preferred embodiments of the invention, is should be readily apparent that various changes and modifications can be made to the invention without departing from the spirit thereof. Overall, it should be recognized that material of the invention has numerous food packaging applications beyond the examples set forth above, such as various snack packaging, as well as the foil label employed in packaging canned dough.

1. A food packaging material comprising:
a barrier-type paper sheet; and
a non-barrier paper sheet laminated to the barrier-type paper sheet with an adhesive, wherein the food packaging material does not employ plastic and is configured to have a moisture vapor transfer rate of less than about 0.021 g H₂O/100 in²/day and an oxygen transfer rate of less than about 0.0463 cc O²/100 in²/day.

2. The food packaging material of claim 1, wherein the barrier-type paper sheet is formed of metallized or aluminum oxide coated paper configured to have a moisture vapor transfer rate of about 0.079 g H₂O/100 in²/day and an oxygen transfer rate of about 0.639 cc O²/100 in²/day.

3. The food packaging material of claim 2, wherein the metallized or aluminum oxide coated paper includes an aluminum layer having an optical density of 2.0-4.5 OD.

4. The food packaging material of claim 3, wherein the metallized paper has weight of about 45-63 grams per square centimeter.

5. The food packaging material of claim 4, further comprising a cold seal adhesive layer formed on the opposite side of the aluminum or aluminum oxide coated layer.

6. The food packaging material of claim 5, wherein the non-barrier paper sheet is formed with bleached paper.

7. The food packaging material of claim 6, wherein the non-barrier paper sheet is formed with Kraft paper having a basis weight of 24 #to 120 #.

8. The food packaging material of claim 7, further comprising an ink layer on the non-barrier paper sheet.

9. The food packaging material of claim 8, further comprising a cold seal release over lacquer formed on the ink layer.

10. A method of forming a packaging material for food without employing plastic comprising:
forming a barrier-type paper sheet;
forming a non-barrier paper sheet with bleached pulp; and
laminating barrier-type paper sheet and the non-barrier paper sheet with bleached pulp together with an adhesive to form a food packaging material which does not employ plastics but has a water transfer rate of less than about 0.021 g H₂O/100 in²/day and an oxygen transfer rate of less than about 0.0463 cc O²/100 in²/day.

11. The method of claim 10, wherein forming the barrier-type paper sheet includes metallizing paper configured to have a water transfer rate of about 0.079 g H₂O/100 in²/day and an oxygen transfer rate of about 0.639 cc O²/100 in²/day.

12. The method of claim 11, wherein metallizing the paper includes depositing an aluminum or aluminum oxide layer having a thickness of about 90 nanometers on a paper sheet to form the barrier-type paper sheet.

13. The method of claim 12, further comprising forming a cold seal adhesive layer on the opposite side of the aluminum or aluminum oxide coated layer.

14. The method of claim 13, further comprising forming an ink layer on the non-barrier paper sheet.

15. The method of claim 14, further comprising forming a cold seal release over lacquer layer on the ink layer.

16. The method of claim 10, wherein laminating is performed such that the packaging material consists of the barrier-type paper sheet and the non-barrier paper sheet with bleached pulp together with the adhesive.

17. The method of claim 16, wherein forming the barrier-type paper sheet includes metallizing paper configured to have a water transfer rate of about 0.079 g H₂O/100 in²/day and an oxygen transfer rate of about 0.639 cc O²/100 in²/day.

18. The food packaging material of claim 1, wherein the food packaging material consists of the barrier-type paper sheet and the non-barrier paper sheet with bleached pulp laminated together with the adhesive.

19. The food packaging material of claim 18, wherein the barrier-type paper sheet is formed of metallized or aluminum oxide coated paper configured to have a moisture vapor transfer rate of about 0.079 g H₂O/100 in²/day and an oxygen transfer rate of about 0.639 cc O²/100 in²/day.
